(19) United States
(12) Patent Application Publication
(10) Pub. No.: US 2014/0258173 A1
(43) Pub. Date: Sep. 11, 2014

(54) PROGRAMMABLE PLANT SYSTEM

(71) Applicant: SYNGENTA PARTICIPATIONS AG, Basel (CH)

(72) Inventors: Matthew Blanchard, Gilroy, CA (US); Joseph Michael DiPaola, Greensboro, NC (US); Nico de Haan, Enkhuizen (NL)

(73) Assignee: SYNGENTA PARTICIPATIONS AG, Basel (CH)

(21) Appl. No.: 14/351,189

(22) PCT Filed: Oct. 18, 2012
(86) PCT No.: PCT/US12/60824

§ 371 Date: Apr. 11, 2014

Related U.S. Application Data
(60) Provisional application No. 61/549,984, filed on Oct. 21, 2011.

(51) Int. Cl. G06Q 10/06

(52) U.S. Cl. CPC G06Q 10/067
USPC 705/348

(57) ABSTRACT

Various systems, methods, and computer program products are described for generating and using a computer model that models development of a plant. For example, a method may include generating a computer model based on empirical data. The computer model may eliminate assumptions regarding growing conditions in order to improve outcome predictions. A method may include recommending, using the computer model, different growing conditions based on a particular plant species and observed growing conditions and/or phenotypic features of the plant. The observed growing conditions may be input by sensors and/or a grower. A method may include generating, using the computer model, a planning schedule that includes optimum growing conditions that facilitates optimal scheduling for plant being cultivated. The recommendations and/or planning schedule may facilitate comparison of phenotypic features of a model plant grown under optimal conditions and a plant being grown by a grower.

### RELATED APPLICATIONS

This application claims priority to U.S. Provisional Application No. 61/549,984, filed Oct. 21, 2011, the disclosure of which is hereby incorporated by reference in its entirety.

### FIELD OF THE INVENTION

The disclosure relates to a modeling development of a plant species and in particular to generating a growth condition recommendation, planning schedule, and/or computer modeling the development of the plant species based on empirical data.

### BACKGROUND

Growers such as food producers, farmers, individuals, and other growers often face difficulty producing consistent quality crops to meet their production, financial, or personal goals. In many cases, growers use random try-and-fail techniques in an attempt to optimize growing conditions and maximize results while minimizing effort and time.

Although conventional plant models attempt to model plant development, these models are not based exclusively on empirical data to guide their outcomes. Accordingly, conventional plant models typically make assumptions that may lead to outcomes that are inaccurate or fail to reflect actual, real-world, conditions. For example, conventional models may be generated for only one developmental plant stage or under growing conditions where responses are quantified to only a single environmental condition. In addition, conventional plant models are typically too general and are not unique to an individual cultivar or variety. The flawed outcomes predicted by conventional models limit their use and effectiveness. Furthermore, conventional uses of plant models are deficient because they fail to take into account actual phenotypic features of a plant being cultivated when making a growth condition recommendation. Conventional uses of plant models further fail to generate planning schedules that are based on empirical data and facilitate efficient planning.

Thus, what is needed is an objective, computational, model based on empirical data acquired over actual plant cultivations, a recommendation tool that recommends growing conditions, and a planning schedule that facilitates efficient growing conditions. These and other problems exist.

### SUMMARY

Various systems, methods, and computer program products are described for recommending growing conditions for plants, generating a planning schedule, and/or modeling plant development.

In some implementations of the invention, for example, a method for recommending a growing condition may include receiving growth condition data and phenotypic data of a plant having a particular age and being cultivated in an environment. In some implementations, the plant being cultivated is a member of a plant species, the growth condition data indicates a growing condition of the environment at the particular age of the plant and the phenotypic data indicates an observed feature of the plant at the particular age.

In some implementations of the invention, the method for recommending a growing condition may include comparing the growth condition data and the phenotypic data with a computer model that is based on empirical data and indicates an optimal progression of the development of the plant species. In some implementations, the optimal progression includes an optimal growing condition and an optimal phenotype at different ages.

In some implementations of the invention, the method for recommending a growing condition may include determining whether the plant being cultivated is optimally developing based on the computer model, the growth condition data, and the phenotypic data.

In some implementations of the invention, the method for recommending a growing condition may include recommending a particular growing condition based on whether the particular plant is optimally developing. For example, if the particular plant is too small or is otherwise not optimally developing, the recommendation may include an indication to adjust a growing condition according to the computer model (e.g., either increase or decrease an amount of light or other growing condition).

In some implementations of the invention, a method for generating a planning schedule may include receiving a selection of a plant species and an input parameter via an interface. In some implementations, the input parameter is associated with a growing condition that affects the development of a plant of the plant species. In some implementations of the invention, the method for generating a planning schedule may include determining a planning schedule based on a computer model, the selected input parameter, and the selected plant species. In some implementations, the planning schedule includes a development milestone. In some implementations, the computer-model models development of the plant using empirical data corresponding to the input parameter. In some implementations of the invention, the method for generating a planning schedule may include communicating the planning schedule. In some implementations, the planning schedule may be communicated via one or more interfaces. The interfaces may include or be communicated via a web page, a mobile application, or other interface.

In some implementations of the invention, a method for generating a computer model that models development of a plant of plant species may include receiving empirical data associated with development of a model plant of a plant species. In some implementations, the empirical data includes an observation of a growing condition at different ages and a phenotypic feature of the model plant at different ages.

In some implementations, the method for generating a computer model may include determining an optimal phenotypic feature at different ages and a corresponding growing condition at different ages. In some implementations, the method for generating a computer model may include generating the computer model based on the optimal phenotypic feature and corresponding growing condition. In some implementations, the computer model indicates an optimal progression of the development of the plant species based on the growing condition and the optimal phenotypic feature at the different ages.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system for generating and using a plant model, according to various implementations of the invention.

FIG. 2 is a screenshot illustration of an interface displaying a planning schedule based on a container size, according to various implementations of the invention.

FIG. 3 is a screenshot illustration of an interface that receives a growing condition input and displays a planning schedule based on the growing condition input, according to various implementations of the invention.

FIG. 4 is a screenshot illustration of an interface that receives a lighting input and displays a planning schedule based on the lighting input, according to various implementations of the invention.

FIG. 5 is a screenshot illustration of an interface displaying various information related to a plant species, according to various implementations of the invention.

FIG. 6 is a screenshot illustration of an interface displaying an optimum schedule for a particular plant species, according to various implementations of the invention.

FIG. 7 is a screenshot illustration of an interface displaying an optimum schedule that various milestones for a particular plant species, according to various implementations of the invention.

FIG. 8 is a screenshot illustration of an interface displaying a crop assessment that facilitates comparison of a plant being cultivated, according to various implementations of the invention.

FIG. 9 is a flow diagram illustrating an example of a process for generating a recommendation for growing a plant, according to various implementations of the invention.

FIG. 10 is a flow diagram illustrating an example of a process for generating a planning schedule, according to various implementations of the invention.

FIG. 11 is a flow diagram illustrating an example of a process for generating a computer model that models development of a plant of plant species, according to various implementations of the invention.

### DETAILED DESCRIPTION

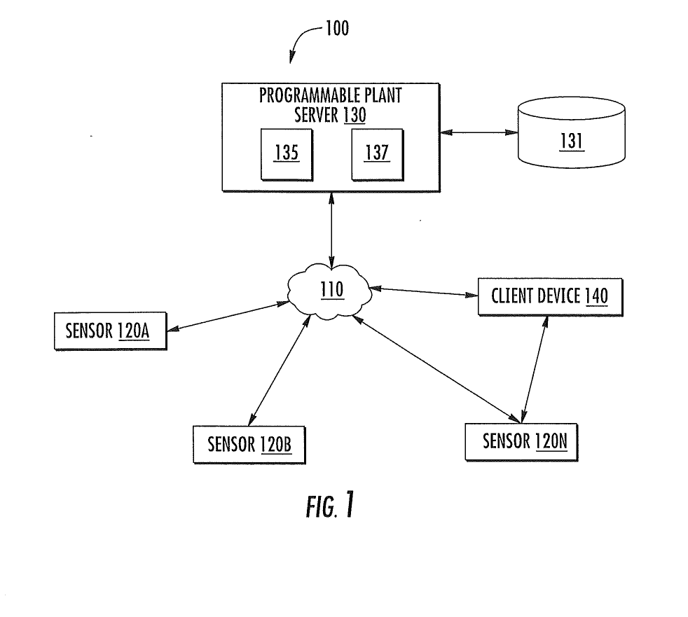

FIG. 1 is a block diagram illustrating a system 100 for generating and using a computer model for plants, according to various implementations of the invention. In some implementations of the invention, system 100 may generate a computer model 137 using empirical data. In some implementations, computer model 137 models development of a plant based on a growing conditions such as light, temperature, container size, water, and/or other condition that affects plant development and that can be measured. In some implementations, system 100 facilitates production of consistent crops from seed sow or cutting stick to flower in the least amount of time. In some implementations, the empirical data is based on years of applied trials at greenhouses globally, scientific experiments and various comparison trials. By generating specific, objective, guidelines based on the empirical data, growers testing the guidelines achieved consistent crops and their production times shortened. For example, the cost of production was less and the return on investment significantly improved. Furthermore, given proper environmental conditions, consistent quality plants may be produced anytime, anywhere, using system 100.

In some implementations of the invention, computer model 137 is based on only observed data. In other words, assumptions that may lead to inaccurate results are not used. In some implementations, computer model 137 is unique to a particular plant species rather than to an entire genus or crop category. In this manner, assumptions that are made when applying conventional models to model particular species of plants may be avoided. In other words, unlike conventional models that make assumptions because they are not designed to model a particular plant species, computer model 137 may model a particular species based on observed data for that species. As used herein, “plant species” is used broadly to describe different types of species of plant, plant varieties, cultivars, intergenic crosses, or hybrids. For example, “member of a plant species” or similar language describes being a member of a particular type of species of plant and/or being a particular type of plant variety, cultivar, intergenic cross or hybrid.

In some implementations, computer model 137 models a plant as a system having particular inputs (growing conditions) that result in particular outputs (phenotypic features). For example, at various times during plant development, computer model 137 may use a growing condition (such as amount of light and/or other growing condition) and its affect on a phenotypic feature (such as an observed size of the plant being cultivated) in order to model the development of the plant. In this manner, growing conditions during plant development and their effect on a phenotypic feature (such as size, color, active roots systems, compact shoot growth in proportion to the finish container, amount of flowering, enhanced keeping quality, or other observable feature of the plant) may be modeled.

In some implementations of the invention, programmable plant server 130 may generate computer model 137. In some implementations of the invention, programmable plant server 130 may receive empirical data associated with development of a model plant for a cultivar. For example, the empirical data includes an observation of a growing condition at different ages and a phenotypic feature of the model plant at different ages. In this manner, different conditions at different ages and their affect on the phenotypic features such as size or bloom may be observed and subsequently modeled. In some implementations, the empirical data may be stored in database 131. As used herein, a “model plant” is any plant species, hybrid, cultivar, variety, or clonethat is observed while developing under various growing conditions and used as a basis for generating computer model 137.

In some implementations, computer model 137 may be iteratively updated such that additional data may fine tune or otherwise change the model. In these implementations, a model plant may include a plant not necessarily grown for observing phenotypic features to be incorporated into the model. For example, data observed in relation to a plant grown by a grower may serve as a model plant to fine tune/change the model.

In some implementations, computer model 137 may be generated from quantified plant developmental responses, phenotypic characteristics, and environmental conditions that are measured in actual crop production systems. Plant data (e.g., time to a developmental milestone) is statistically compared with environmental data (e.g., temperatures and light) to generate a model that predicts an outcome. In some implementations, computer model 137 may consist of both linear and nonlinear equations with cultivar-specific coefficients. In some implementations, each component of computer model 137 assumes that individual environmental factors contribute to a plant response and that some of these factors can also interact. For example, under warm temperature conditions, computer model 137 may predict an interactive effect of temperature and light integral on phenotypic features. In some implementations of the invention, programmable plant server 130 may determine an optimal phenotypic feature at the different ages and a corresponding growing condition at the different ages. For example, if large flowers are desirable, the growing condition(s) at a particular age that result in the largest flowers (i.e., the optimum) relative to other growing conditions at the same age may be determined. In this manner, optimum growing condition(s) at a particular age of a model plant may be determined for a given plant species.

In some implementations of the invention, programmable plant server 130 may generate computer model 137 based on the optimal phenotypic feature and corresponding growing condition. As previously discussed, computer model 137 may indicate an optimal progression of the development of the plant species based on the growing condition and the optimal phenotypic feature at the different ages.

In some implementations of the invention, system 100 may recommend particular growing conditions to be used based on an optimum predicted by computer model 137. For example, based on computer model 137, system 100 may recommend altering an amount of light received by a plant being cultivated based on the particular species of the plant being cultivated, the amount of light that a plant being cultivated is receiving, its age, and/or its current size. The recommendation may help the grower optimize growing conditions for the plant.

In some implementations of the invention, system 100 may generate a planning schedule for various species of plants using computer model 137. The planning schedule may include, among other information, a container size to use, other growing conditions, and various milestones such as flowering times. The planning schedule may help a grower identify which plants to grow, when they should be grown, an expected rate of growth, and/or other information that facilitates plant selection or optimal conditions.

The foregoing are non-limiting examples associated with various implementations of the invention. Other uses and implementations of system 100 with respect to various system components will be apparent to those skilled in the art based on the description below.

According to various implementations of the invention, system 100 may include, but is not limited to, a network 110, sensors 120 (illustrated in FIG. 1 as sensors 120A, 120B, . . . , 120N; used interchangeably with “sensor 120” hereinafter unless specifically described otherwise), a programmable plant server 130, and a client device 140. In some implementations of the invention, programmable plant server 130 may include or otherwise be coupled to a database 131. In some implementations of the invention, sensors 120, programmable plant server 130, database 131, and client device 140 may be communicably coupled to one another via a network 110. Network 110 may include a Local Area Network, a Wide Area Network, a cellular communications network, a Public Switched Telephone Network, and/or other network or combination of networks.

In some implementations of the invention, sensors 120 may include various devices that sense growing conditions associated with a plant. For example, sensors 120 may include, without limitation, thermisters, thermocouples, infrared sensors, photosynthetic active radiation sensors, pyranometers, electrical conductivity sensors, pH sensors, soil moisture probes, carbon dioxide and/or oxygen sensors.

In operation, sensors 120 may be placed nearby or within an environment, such as a container, other container, greenhouse, or land where a plant is cultivated. For example and without limitation, all or a portion of a sensor 120 may be disposed within the soil or other growth medium in which a plant is being cultivated in order to sense a growing condition such as moisture, nutrient, or pH levels within the soil and/or growing conditions such as ambient temperature and light. As would be appreciated, sensors 120 may be placed wherever growth conditions may be sensed or otherwise observed. In some implementations, multiple sensors 120 may sense different portions/loci of an environment. For example and without limitation, different sensors 120 may be placed at different locations within a greenhouse in order to sense growing conditions throughout the greenhouse.

In some implementations of the invention, client device 140 may include, without limitation, a telephone, a computer, a smartphone, a cellular phone, a tablet computer, and/or other device that can be used to communicate with programmable plant server 130 and/or sensors 120.

In some implementations of the invention, programmable plant server 130 may recommend a growing condition for a plant being cultivated based on, among other things, various input from sensors 120 and/or client device 140. For example, in some implementations, programmable plant server 130 may receive sensor data associated with sensors 120 sensing an environment of the plant being cultivated, phenotypic data that describes a phenotypic feature of the plant being cultivated, and/or age information that indicates an age of the plant being cultivated.

In some implementations of the invention, sensors 120 may communicate sensor data that indicates one or more growing conditions sensed from an environment of a plant to programmable plant server 130. In other words, programmable plant server 130 may receive sensor data from sensors 120. In some implementations, the sensor data may be stored in database 131 for later retrieval and analysis. In some implementations, the sensor data may be used to calibrate or otherwise alter computer model 137.

In some implementations of the invention, sensors 120 may communicate the sensor data in real-time or store the sensor data and periodically communicate the stored sensor data at intervals or other mechanisms for communicating the sensor data. In some implementations of the invention, sensors 120 may communicate the sensor data in response to a request from programmable plant server 130 and/or from client device 140. In some implementations of the invention, the sensor data is communicated in response to a user such as a farmer or other grower uploading the sensor data to programmable plant server 130 via client device 140.

In some implementations of the invention, sensors 120 may communicate the sensor data directly to programmable plant server 130. In other implementations, sensors 120 may communicate the sensor data via an intermediate device, such as client device 140 or other device communicably coupled to sensors 120 and programmable plant server 130. In these implementations, sensors 120 may be coupled to the intermediate device via a wired (such as Universal Serial Bus) or wireless (such as BLUETOOTH) communication link and/or via network 110.

In some implementations of the invention, the user may upload the sensor data or other growth condition data, phenotypic data, and age of the plant being cultivated to programmable plant server 130 via client device 140. In some implementations, programmable plant server 130 may generate an interface such as a website or other interface to receive the various inputs. In some implementations, programmable plant server 130 may receive the various inputs via a remote interface such as a mobile application operating on client device 140 such as a mobile device. In some implementations, the growth condition data may be sensed automatically by sensor 120. In these implementations, the sensed growth condition data may be communicated to client device 140 via a communication link and/or manually by the user, such as the user obtaining the sensor data from sensor 120 and manually inputting the sensor data using client device 140. In other implementations, the user may manually sense a growing condition such as by measuring ambient temperature with a thermometer and inputting the temperature via client device 140. In some implementations, the phenotypic data may be measured or observed by the user and uploaded to programmable plant server 130. In some implementations, photographic or other imaging equipment may be used to calculate plant size or other phenotypic feature of the plant for comparison with the model. In other words, in some implementations, a phenotypic feature of a plant may be automatically obtained from a sensor 120, which can include imaging and/or other equipment that can observe the phenotypic feature.

In some implementations of the invention, programmable plant server 130 may compare the growth condition data and the phenotypic data with computer model 137. In some implementations, computer model 137 indicates an optimal progression of the development of the plant species. The optimal progression may include an optimal growing condition and an optimal phenotype at different ages. In other words, computer model 137 models particular growing conditions as the plant develops to achieve desirable phenotypic outcomes. In these implementations, programmable plant server 130 may compare the received growth condition data, phenotypic data, and age information to the optimal progression to determine whether the plant being cultivated is developing according to an optimum predicted by computer model 137 (i.e., is optimally developing).

In some implementations, based on the determination, programmable plant server 130 may generate a recommendation to adjust the growing condition. For example, based on an age and a size of a developing plant observed and input by a grower, programmable plant server 130 may determine that the plant being cultivated is smaller for its age than predicted by computer model 137. Accordingly, programmable plant server 130 may recommend a change in growing condition such as additional light or increased temperature to be given to the plant.

In some implementations of the invention, programmable plant server 130 may indicate a photograph (such as a camera photo or video image still) of a particular plant species at various ages. For example, programmable plant server 130 may cause a photograph of the plant species to be communicated. In some implementations, the photograph may convey an optimum appearance of a model plant of the plant species according to the plant's age and/or optimal growing condition as predicted by computer model 137. In this manner, the photograph may be used compare an appearance of a plant being cultivated to the model plant. In other words, the photograph may facilitate a determination of whether the plant being cultivated is optimally developing. In some implementations, the photograph may convey an optimum appearance a model plant of the plant species after the plant's age and/or based on an optimal growing condition as predicted by computer model 137. In this manner, the photograph may be used to determine how a plant being cultivated should look in the future as predicted by computer model 137.

In some implementations, instead of or in addition to a photograph described throughout this disclosure, other graphical representations that indicate an actual appearance (i.e., phenotypic features) of a plant may be used so long as the graphical representation is photographic in that it depicts the actual phenotypic features of the particular plant being depicted.

In some implementations of the invention, programmable plant server 130 may communicate a planning schedule for a particular plant species. In other words, different plant species have different development paths and requirements and will accordingly be associated with different planning schedules. In some implementations, the planning schedule includes various milestones such as germination or sticking of cuttings, and flowering times, ideal or optimal growing conditions, photographs of the plant species, which may include photographs at various developmental stages/ages, and/or other information. In these implementations, the planning schedule may guide selection of a plant species to cultivate as well as recommend cultivation protocols for the plant species. For example, after viewing the planning schedule, the user may select a particular plant species to cultivate, determine when/how the plant species should be cultivated, and/or determine how a plant species should (i.e., is expected to) develop over time.

In some implementations of the invention, programmable plant server 130 may expose or otherwise communicate an interface that communicates the planning schedule based on a plant species. In some implementations of the invention, programmable plant server 130 may receive a selection of a plant species and an input parameter via the interface. In some implementations of the invention, the input parameter is associated with a growing condition that affects the development of a plant of the plant species.

In some implementations of the invention, programmable plant server 130 may determine a planning schedule based on computer model 137, the selected input parameter, and the selected plant species. In some implementations of the invention, the planning schedule includes a development milestone such as, without limitation, a germination time, a sticking cutting time, a flowering time, or other developmental milestone. For example, the planning schedule may include an indication of a time when a plant of the selected plant species is expected to germinate, bloom, or enter/complete another developmental milestone. In some implementations of the invention, the planning schedule may include information associated with each developmental milestone. For example and without limitation, the planning schedule may include an optimal growing condition (such as container size, finish size, amount of light, temperature, and/or other growing condition), photographs of model plants, and/or other information for each developmental milestone. In some implementations, the information is different for each milestone. In other words, each milestone may be associated with different recommended growing conditions, photographs, and/or other information.

In some implementations of the invention, the interface displaying the planning schedule facilitates user selection of a plant species for which to view a planning schedule. For example, programmable plant server 130 may store, such as in database 131, or otherwise generate planning schedules for different plant species. In some implementations, the planning schedules are generated based on an optimum predicted by computer model 137.

In some implementations of the invention, the interface displaying the planning schedule facilitates user selection of one or more growing conditions. In these implementations, the effect of the growing condition on the planning schedule is displayed. For example and without limitation, the planning schedule may be altered by changing various growing conditions such as temperature or light. In a particular example, changing day length may alter flowering times of a particular plant species and therefore will change the planning schedule. In other words, different growing conditions may be associated with different planning schedules. The planning schedule may facilitate an analysis of which growing condition should be used to achieve a desired development of a plant.

In some implementations of the invention, programmable plant server 130 may communicate the planning schedule. For example and without limitation, programmable plant server 130 may communicate the planning schedule via a website exposed by programmable plant server 130, via a webservice that interfaces with third party websites or other interfaces, via a mobile application operating on a mobile device, or other interface as would be appreciated. In this manner, a user may access the planning schedule via client device 140 or other device that may receive the planning schedule. In some implementations, for example, the user may logon to a website or mobile application to input parameters and view the planning schedule.

In some implementations of the invention, programmable plant server 130 may input the selected input parameter into computer model 137 such that the selected input parameter is used by computer model 137 to determine the planning schedule. In these implementations, computer model 137 may be configured such that different input parameters (such as growth conditions) may affect an outcome of computer model 137. In other implementations, computer model 137 is specific for each input parameter. For example, computer model 137 may model a plant of a plant species based only on a particular container size.

In some implementations of the invention, programmable plant server 130 may select computer model 137 associated with the selected plant species. In these implementations, computer model 137 may be specific for a particular plant species. In other words, different computer models 137 may correspond to different plant species.

According to various implementations of the invention, programmable plant server 130 may include a processor 135, a memory 137, and/or other components that facilitate the functions of programmable plant server 130 described herein. In some implementations of the invention, processor 135 includes one or more processors configured to perform various functions of programmable plant server 130. In some implementations of the invention, memory 137 includes one or more tangible (i.e., non-transitory) computer readable media. Memory 137 may include one or more instructions, that when executed by processor 135, configure processor 135 to perform the functions of programmable plant server 130.

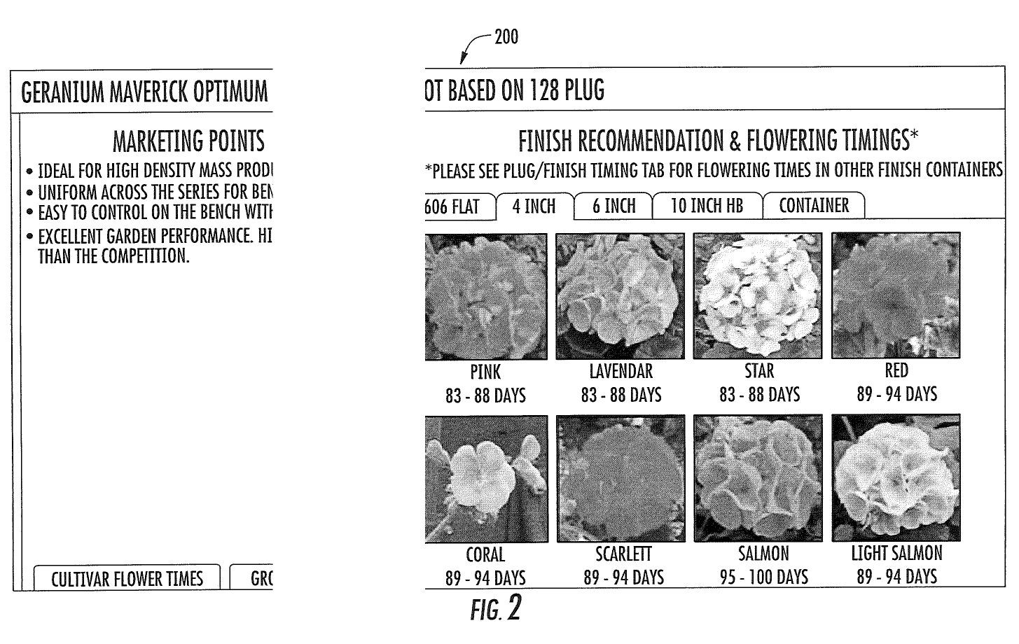

FIG. 2 is a screenshot illustration of an interface 200 displaying a planning schedule based on a container size, according to various implementations of the invention. As would be appreciated, the screenshots illustrated in FIG. 2 and other drawing figures are for illustrative purposes only. Various components may be added, deleted, moved, or otherwise changed so that the configuration, appearance, and/or content of the screenshots may be different than as illustrated in the Figures.

In some implementations, all or some of the information illustrated in FIG. 2 and other screenshot illustrations may be based on a computer model (such as computer model 137) that models development of the plant species. In some implementations, all or some of the content and/or layout of interface 200 and other interfaces illustrated in other Figures may be generated or communicated by programmable plant server 130.

For example, programmable plant server 130 may expose an interface such as a web page, mobile application interface, web service, or other interface that is configured to communicate content and/or layout of the various interfaces described herein. The exposed interface may cause user interface elements (such as drop down menus, text inputs, etc.) to be displayed that receive input (such as a plant species indication, a growing condition, and/or photograph). Based on one or more of the received inputs, the exposed interface may cause the various interfaces illustrated herein to be displayed. Thus, in operation, the various interfaces illustrated in FIG. 2 and in other drawing figures may be accessed via a web page, a mobile application, or other interface that is configured to communicate such interfaces.

In some implementations of the invention, the planning schedule may include information associated with a particular cultivar, such as Pelargonium Maverick™ as well as different varieties of the particular species. As illustrated in FIG. 2, for example, the planning schedule includes Marketing Points that describe overall benefits of cultivating the displayed species, cultivar, variety, etc. of a plant. In some implementations of the invention, the planning schedule may display more than one displayed species, as illustrated in FIG. 2.

In some implementations of the invention, the planning schedule displays a finish recommendation and flowering timings of the displayed species. In some implementations of the invention, the planning schedule displays a photograph of the displayed species (and may include photographs of different varieties of the species). In these implementations, the user may view an optimum appearance of the plant species and the flowering timing for achieving the optimum appearance.

In some implementations of the invention, the planning schedule and/or interface 200 facilitates selection of different growth conditions that may affect the flowering timings. As illustrated, for example, the planning schedule and/or interface 200 displays a selectable plurality of inputs such as a container input (illustrated in FIG. 2 as “606 Flat,” “4 Inch,” “6 Inch,” “10 Inch HB,” “Container”) such that upon selection, different flowering times corresponding to the selected container is displayed. In this manner, the planning schedule displays the affect of using different containers on flowering times.

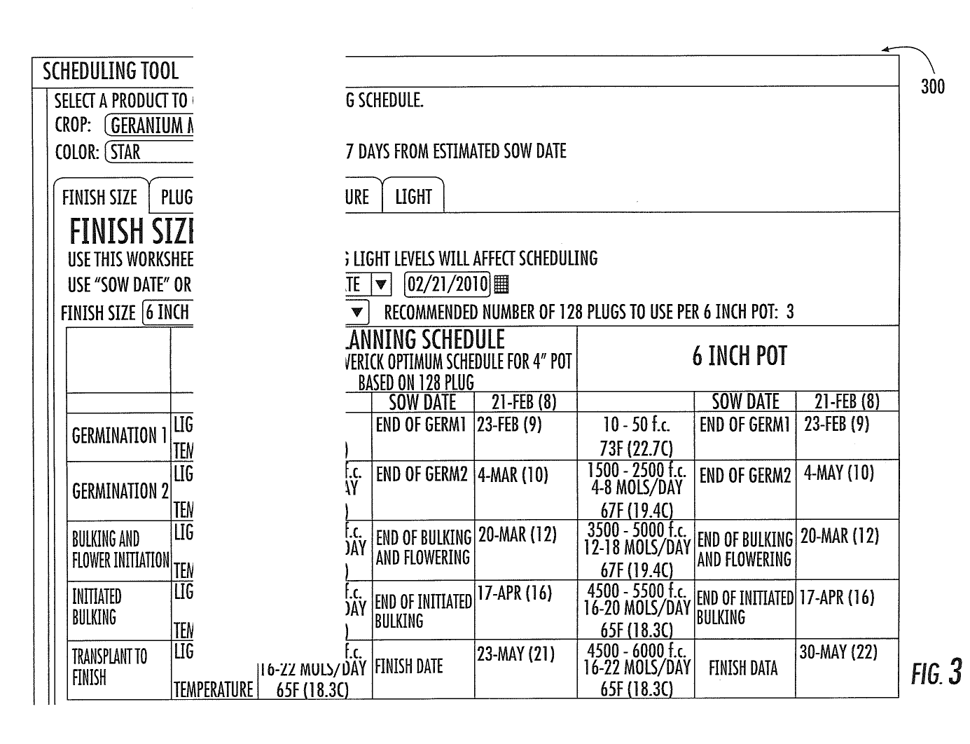

FIG. 3 is a screenshot illustration of an interface 300 that receives a plant species input and a growing condition input and displays a planning schedule based on the inputs, according to various implementations of the invention. In some implementations of the invention, interface 300 displays a selectable plurality of plant species for which the planning schedule is displayed. As would be appreciated, in FIG. 3 and other drawing figures, various interface members may be used to receive inputs. For example, instead of a drop-down selectable menu, other inputs such as open text may be used instead or in addition to the drop-down menu. In some implementations, interface 300 displays a selectable plurality of particular varieties (such as “color”) of the plant species. In some implementations, interface 300 displays a selectable plurality of types of growing conditions such as “Finish Size,” “Plug Tray Size,” “Temperature,” and “Light.” As illustrated in FIG. 3, for example, “Finish Size” for “Geranium Maverick Star” has been selected. In some implementations, interface 300 displays a selectable plurality of inputs for the growing condition such as different container sizes. Based on the selected plant species (e.g., “Geranium Maverick Star”), growing condition (e.g., “Pot Size”) and its value (e.g., “6 inch pot”), interface 300 displays the planning schedule.

In some implementations of the invention, the planning schedule may include various milestones (illustrated in FIG. 3 as “Germination 1,” “Germination 2,” “Bulking and Flower Initiation,” “Initiated Bulking,” and “Transplant to Finish”). In some implementations, the planning schedule includes growth condition recommendations such as amount of light and temperature for each milestone. In some implementations, the planning schedule includes timing or age of the plant associated with each milestone.

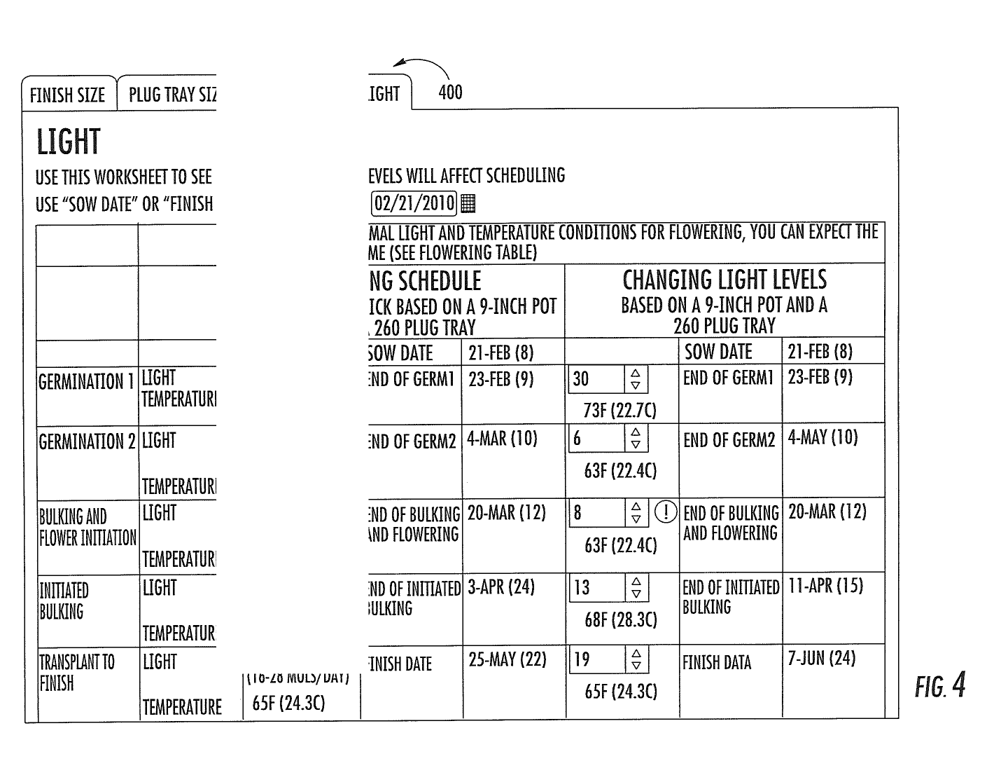

FIG. 4 is a screenshot illustration of an interface 400 that receives a lighting input and displays a planning schedule based on the lighting input, according to various implementations of the invention. As illustrated, interface 400 displays the planning schedule that results when the “light” growth condition is selected instead of the “finish size” illustrated in FIG. 3. As illustrated, interface 400 displays an adjustable light level input (although other types of inputs may be used, as would be appreciated) such that the effect of different light levels on the planning schedule may be determined. In some implementations, as illustrated in FIG. 4, light levels at each milestone may be adjusted to determine the input light level's effect on the milestone.

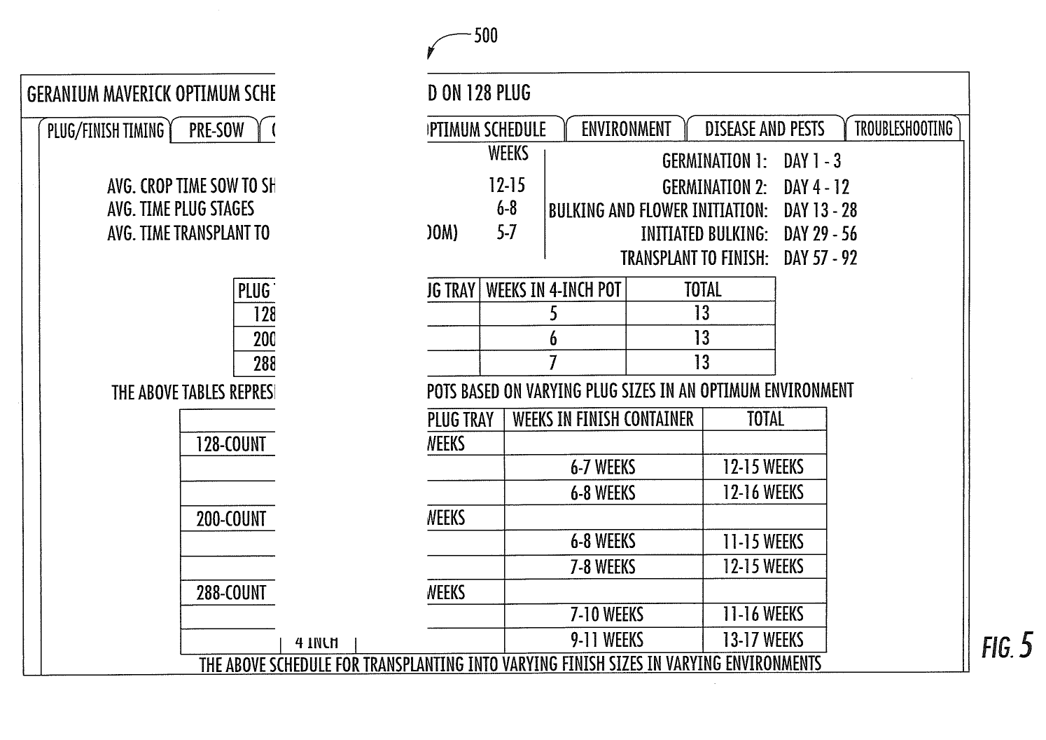

FIG. 5 is a screenshot illustration of an interface 500 displaying various information related to a plant species, according to various implementations of the invention. In some implementations of the invention, interface 500 displays a plurality of different information associated with the plant species. For example, as illustrated, interface 500 displays a plurality of selectable tabs corresponding to different information such as “Plug/Finish Timing,” “Pre-sow,” “Cultural Support,” “Optimum Schedule,” “Environment,” “Disease and Pests,” and “Troubleshooting.”

As illustrated, the “Plug/Finish Timing” tab causes information related to finish times for different containers/plug sizes. In some implementations, an average crop time sow to shipping, an average time plug stages, and an average time transplant to flowering may be displayed. In these implementations, information that describes an overall expected timing for the plant species is displayed, facilitating a decision whether and when a plant species should be cultivated.

In some implementations, interface 500 displays different milestones and corresponding timeline expectations for the plant species. In other words, interface 500 may display various milestones at different ages of a plant of the plant species. For example, a “Germination 1,” “Germination 2,” “Bulking and Flower initiation,” “Initiated Bulking” and “Transplant to Finish” estimates may be displayed alongside their corresponding ages at which the milestone is expected to occur.

In some implementations, interface 500 displays expected times for the plant of the plant species to be grown in plug trays (as illustrated “128-Count,” “200-Count,” and “288-Count”) and same-sized pots (as illustrated “4-inch pot”) based on an optimum environment (which may be displayed in other interfaces, such as interface 600, described herein). In this manner, interface 500 facilitates an understanding of how different plug sizes affect a proper amount of time to be grown in one environment/container and transplanted into another environment/container when an optimum environment is achieved.

In some implementations, interface 500 displays expected times for the plant of the plant species to be grown in plug trays (illustrated “128-Count,” “200-Count,” and “288-Count”) and different-sized pots (as illustrated “606 Flat” and “4 Inch” pot) based on varying (i.e., non-optimum) environments. In this manner, interface 500 facilitates an understanding of how different plug sizes, container sizes, and other varying environment conditions affect a proper amount of time to be grown in one environment/container and transplanted into another environment/container when an optimum environment is not achieved.

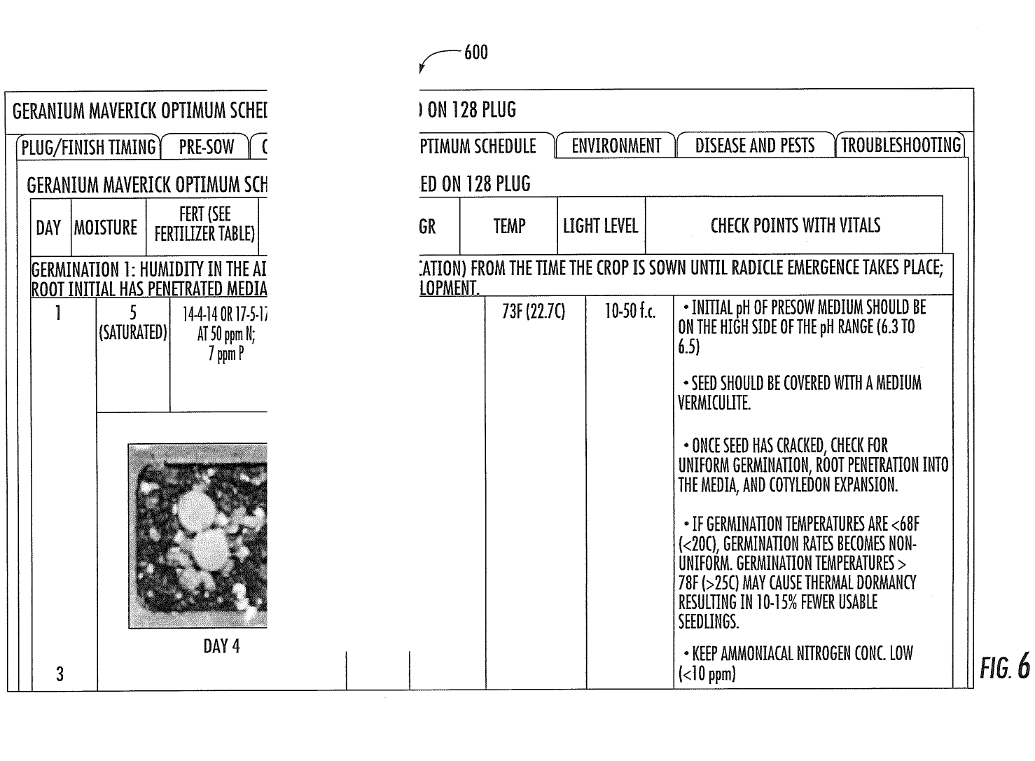

FIG. 6 is a screenshot illustration of an interface 600 displaying an optimum schedule for a particular plant species, according to various implementations of the invention. In some implementations, the optimum schedule is based on a particular pot and/or plug size. In other words, different containers/environments may be associated with different optimum schedules. For example, as illustrated, interface 600 displays an optimum schedule for growing “Geranium Maverick” in a 4″ pot based on 128 plug.

In some implementations of the invention, interface 600 displays one or more optimum growing conditions. For example, as illustrated, interface 600 displays “moisture,” fertilizer (“Fert”), “pH,” Electrical Conductivity (“EC”), Plant Growth Regulator (“PGR”), temperature (“Temp”), and “Light level” growing conditions as well as corresponding optimum levels for each.

In some implementations of the invention, interface 600 indicates when such optimum growing conditions should be applied. In other words, interface 600 displays an optimum growing condition that should be applied for different ages of the plant being cultivated. For example, as illustrated, interface 600 displays optimum growing conditions for different days (i.e., ages).

In some implementations of the invention, interface 600 associates optimum growing conditions with different milestones. For example, as illustrated, optimum growing conditions are associated with a “Germination 1” milestone, where different optimum growing conditions are associated with germination. In some implementations, interface 600 includes a description for each milestone that provides information for guiding growth during the milestone.

In some implementations of the invention, interface 600 indicates one or more check points that guide development of the plant. In some implementations, each check point is associated with an age of the plant such that at each age, a check point may be used to ensure proper environmental conditions and/or developmental progress are being met. In some implementations, some or all of the check points (such as those associated with pH levels) are derived from a computer model such as computer model 137.

In some implementations of the invention, interface 600 communicates a photograph of a model plant of the plant species being displayed. The photograph may indicate a target or optimum appearance of the plant being grown. In other words, the photograph was taken when a model plant was grown under optimum growing conditions (such as the growing conditions illustrated in FIG. 6). In this manner, the user/grower may gain an expectation of how the plant should look or compare their plant being cultivated with the photograph in order to determine whether the plant being cultivated has an appearance (i.e., phenotypic features) similar to the model plant. In some implementations, the photograph is associated with an age. For example, as illustrated in FIG. 6, the photograph illustrates the model plant's appearance at day 4.

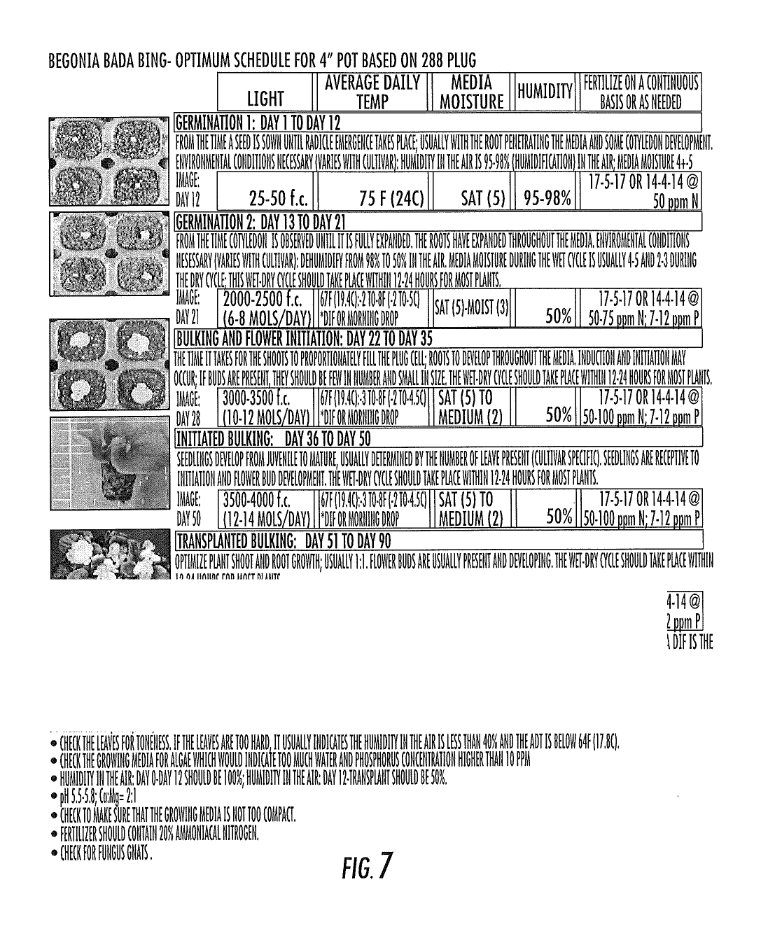

FIG. 7 is a screenshot illustration of an interface 700 displaying an optimum schedule that includes various milestones for a particular plant species such as “Begonia Bada Bing,” according to various implementations of the invention. In some implementations, interface 700 displays information that is similar to information displayed by interface 600 such as optimum growing conditions and milestone descriptions/guides. Interface 700 illustrates different milestones (“Germination 1,” “Germination 2,” “Bulking and Flower Initiation,” “Initiated Bulking,” and “Transplanted Bulking”) and corresponding photographs at a particular age for each milestone. In some implementations, interface 700 displays key cultural points of development/progress associated with the particular species. The cultural points may include general knowledge and/or cultural suggestions for the particular species. For example, key points for Begonia Bada Bing may include, among other things, a flowering mechanism that describes when and how flowering may occur, development progress checks such as checking leaves for toneness, checking growth media, humidity, fertilizer, and disease/pests (such as fungus gnats), and/or other descriptions that facilitate developmental progress or recommendations.

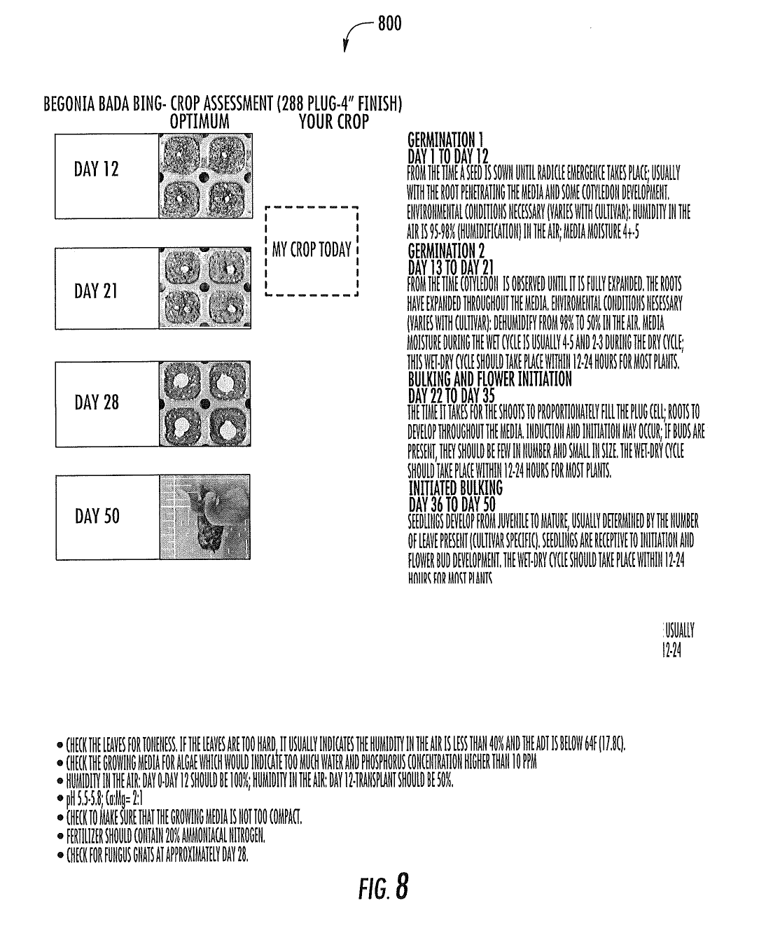

FIG. 8 is a screenshot illustration of an interface 800 displaying a crop assessment that facilitates comparison of a plant being cultivated, according to various implementations of the invention. In some implementations, crop assessment interface 800 displays information similar to interface 700 such as key points, milestones, photographs associated with optimum growing conditions and descriptions for each milestone. In some implementations, crop assessment interface 800 receives and displays a photograph of a plant being cultivated such that the photograph may be compared to photographs of a model plant grown according to optimum conditions. In this manner, a grower may track progress of the plant being cultivated by comparing its phenotypic features to a model plant's phenotypic features. For example, a grower may upload one or more photographs of a plant being cultivated at one or different ages in order to assess the progress of the plant being cultivated. The uploaded (i.e., received) photograph may be stored in a memory for later display or may be displayed in real-time.

In some implementations, the received and displayed photograph may be displayed adjacent to the milestone photographs. In some implementations, a single received photograph may be displayed according to the age of the photographed plant. For example, the received photograph may be displayed nearby one or more milestones based on the age of the photographed plant in a timeline fashion. In some implementations, multiple photographs of the plant at different ages may be displayed along with the milestone photographs.

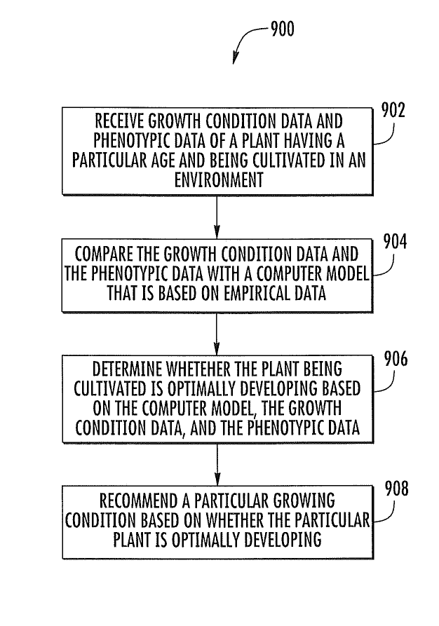

FIG. 9 is a flow diagram illustrating an example of a process 900 for generating a recommendation for growing a plant, according to various implementations of the invention. The various processing operations and/or data flows depicted in FIG. 9 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 902, process 900 may include receiving growth condition data and phenotypic data of a plant having a particular age and being cultivated in an environment, where the plant being cultivated is a member of a plant species, the growth condition data indicates a growing condition of the environment at the particular age and the phenotypic data indicates an observed feature of the plant at the particular age.

In some implementations of the invention, in an operation 904, process 900 may include comparing the growth condition data and the phenotypic data with a computer model based on empirical data and that indicates an optimal progression of the development of the plant species. The optimal progression includes an optimal growing condition and an optimal phenotype at different ages.

In some implementations of the invention, in an operation 906, process 900 may include determining whether the plant being cultivated is developing optimally based on the computer model, the growth condition data, and the phenotypic data.

In some implementations of the invention, in an operation 908, process 900 may include recommending a particular growing condition based on whether the particular plant is optimally developing. For example, if the particular plant is too small or is otherwise not optimally developing, process 900 may recommend either increasing or decreasing an amount of light or adjusting another growing condition according to the computer model.

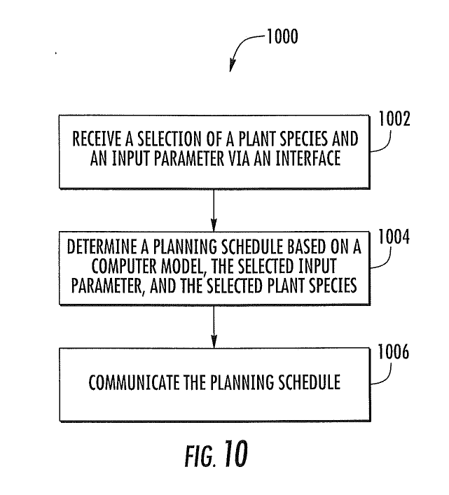

FIG. 10 is a flow diagram illustrating an example of a process 1000 for generating a planning schedule, according to various implementations of the invention. In some implementations, in an operation 1002, process 1000 may include receiving a selection of a plant species and an input parameter via an interface, where the input parameter is associated with a growing condition that affects the development of a plant of the plant species. In some implementations, in an operation 1004, process 1000 may include determining a planning schedule based on a computer model, the selected input parameter, and the selected plant species, the planning schedule comprising a development milestone. In some implementations, the computer model models development of the plant using empirical data corresponding to the input parameter. In some implementations, in an operation 1006, process 1000 may include communicating the planning schedule. In some implementations, the planning schedule may be communicated via one or more interfaces. The interfaces may include or be communicated via a web page, a mobile application, or other interface.

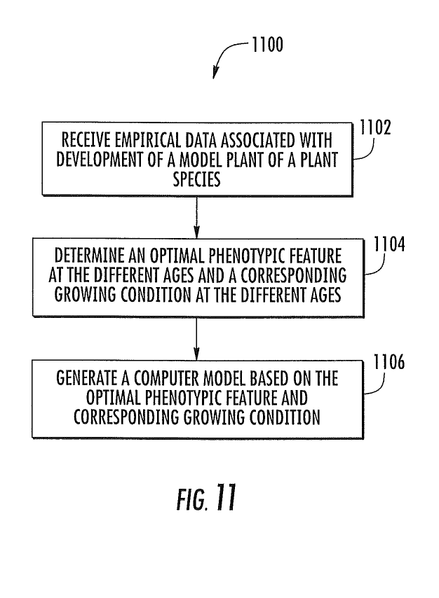

FIG. 11 is a flow diagram illustrating an example of a process 1100 for generating a computer model that models development of a plant of plant species, according to various implementations of the invention. In some implementations, in an operation 1102, process 1100 may include receiving empirical data associated with development of a model plant of a plant species, wherein the empirical data comprises an observation of a growing condition at different ages and a phenotypic feature of the model plant at different ages, wherein the growing condition affects the development of the model plant.

In some implementations, in an operation 1104, process 1100 may include determining an optimal phenotypic feature at the different ages and a corresponding growing condition at the different ages. In some implementations, in an operation 1106, process 1100 may include generating a computer model based on the optimal phenotypic feature and corresponding growing condition, wherein the computer model indicates an optimal progression of the development of the plant species based on the growing condition and the optimal phenotypic feature at the different ages.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for generating a recommendation for growing a plant, comprising:
receiving, by a server having a processor, growth condition data and phenotypic data of a plant having a particular age and being cultivated in an environment, wherein the plant being cultivated is a member of a plant species, the growth condition data indicates a growing condition of the environment at the particular age and the phenotypic data indicates an observed feature of the plant at the particular age;
comparing, by the server, the growth condition data and the phenotypic data with a computer model, wherein the computer model is based on empirical data and indicates an optimal progression of the development of the plant species, and wherein the optimal progression comprises an optimal growing condition and an optimal phenotype at different ages;
determining, by the server, whether the plant being cultivated is optimally developing based on the computer model, the growth condition data, and the phenotypic data; and
recommending, by the server, a particular growing condition based on whether the particular plant is optimally developing.

2. The method of claim 1, wherein the growing condition comprises a temperature condition, a lighting condition, or a watering condition.

3. The method of claim 1, wherein determining a recommendation comprises comparing the size of the particular plant at the particular age to the optimal size from the computer model corresponding to the particular age.

4. The method of claim 1, further comprising:
causing, by the server, a photograph of the model plant to be displayed.

5. The method of claim 4, wherein causing a photograph of the model plant to be displayed further comprises:
causing, by the server, the photograph of the model plant to be displayed at an age corresponding to the particular age to be displayed, the photograph indicating an optimal appearance of the particular plant at the particular age.

6. The method of claim 4, wherein causing a photograph of the model plant to be displayed further comprises:
causing, by the server, the photograph of the model plant to be displayed at an age after the particular age to be displayed, the photograph indicating an optimal appearance of the particular plant after the particular age.

7. A system for generating a recommendation for growing a plant, comprising:
a server comprising a processor, the server configured to:
receive growth condition data and phenotypic data of a plant having a particular age and being cultivated in an environment, wherein the plant being cultivated is a member of a plant species, the growth condition data indicates a growing condition of the environment at the particular age and the phenotypic data indicates an observed feature of the plant at the particular age;
compare the growth condition data and the phenotypic data with a computer model, wherein the computer model is based on empirical data and indicates an optimal progression of the development of the plant species, and wherein the optimal progression comprises an optimal growing condition and an optimal phenotype at different ages;
determine whether the plant being cultivated is optimally developing based on the computer model, the growth condition data, and the phenotypic data; and
recommend a particular growing condition based on whether the particular plant is optimally developing.

8. The system of claim 7, wherein the growing condition comprises a temperature condition, a lighting condition, or a watering condition.

9. The system of claim 7, the server further configured to compare the size of the particular plant at the particular age to the optimal size from the computer model corresponding to the particular age.

10. The system of claim 7, the server further configured to cause a photograph of the model plant to be displayed.

11. The system of claim 10, the server further configured to cause the photograph of the model plant to be displayed at an age corresponding to the particular age to be displayed, the photograph indicating an optimal appearance of the particular plant at the particular age.

12. The system of claim 10, the server further configured to cause the photograph of the model plant to be displayed at an age after the particular age to be displayed, the photograph indicating an optimal appearance of the particular plant after the particular age.

13. A computer-implemented method for generating a planning schedule for plants, comprising:
receiving, by a server having a processor, a selection of a plant species and an input parameter via an interface, wherein the input parameter is associated with a growing condition that affects the development of a plant of the plant species;
determining, by the server, a planning schedule based on a computer model, the selected input parameter, and the selected plant species, the planning schedule comprising a development milestone, wherein the computer model models development of the plant using empirical data corresponding to the input parameter; and
communicating, by the server, the planning schedule.

14. The computer implemented method of claim 13, further comprising:
inputting, by the server, the selected input parameter into the computer model, wherein the selected input parameter is used by the computer model to determine the planning schedule.

15. The computer implemented method of claim 13, further comprising: selecting a computer model associated with the particular plant species.

16. The computer implemented method of claim 13, wherein the planning schedule further comprises a recommended growing condition for different plant ages.

17. The computer implemented method of claim 16, further comprising:
causing a photograph of the plant species to be displayed, the photograph indicating an optimal appearance of the plant species at a particular age.

18. The computer implemented method of claim 13, wherein the plurality of input parameters comprise a finish size, a plug tray size, a temperature, or a lighting condition.

19. A computer implemented method for generating a computer model that models development of a plant of plant species, comprising:
receiving, by a computing device, empirical data associated with development of a model plant of a plant species, wherein the empirical data comprises an observation of a growing condition at different ages and a phenotypic feature of the model plant at different ages, wherein the growing condition affects the development of the model plant;
determining, by the server, an optimal phenotypic feature at the different ages and a corresponding growing condition at the different ages; and
generating, by the server, a computer model based on the optimal phenotypic feature and corresponding growing condition, wherein the computer model indicates an optimal progression of the development of the plant species based on the growing condition and the optimal phenotypic feature at the different ages.
